(19) United States
(12) Patent Application Publication
(10) Pub. No.: US 2026/0141617 A1
(43) Pub. Date: May 21, 2026

(54) METHOD AND ELECTRONIC DEVICE FOR 3D SEMANTIC SCENE RECONSTRUCTION USING REGIONAL MEMORY BANK

(71) Applicants: Hon Hai Precision Industry Co., Ltd., New Taipei City (TW); National Yang Ming Chiao Tung University, Hsinchu (TW)

(72) Inventors: I-Bin Liao, New Taipei City (TW); Yung-Hui Li, New Taipei City (TW); Yu-Wen Tseng, Hsinchu (TW); Sheng-Ping Yang, Hsinchu (TW); Hong-Han Shuai, Hsinchu (TW); Wen-Huang Cheng, Hsinchu (TW)

(73) Assignees: Hon Hai Precision Industry Co., Ltd., New Taipei City (TW); National Yang Ming Chiao Tung University, Hsinchu (TW)

(21) Appl. No.: 19/393,580

(22) Filed: Nov. 19, 2025

Related U.S. Application Data
(60) Provisional application No. 63/722,565, filed on Nov. 19, 2024.

(30) Foreign Application Priority Data
Sep. 22, 2025 (TW) 114136381

(51) Int. Cl. G06T 15/10; G06T 7/50; G06T 15/08

(52) U.S. Cl. CPC G06T 15/10; G06T 7/50; G06T 15/08

(57) ABSTRACT

Provided are a method and an electronic device for 3D semantic scene reconstruction. The method includes: a 2D image is obtained, and multiple token features and multiple voxel features are generated according to the 2D image; the token features are added to a regional memory bank, which includes multiple key-value pairs; a depth map is generated according to the 2D image, and a reconstruction mask is generated according to the depth map and the token features; the reconstruction mask includes multiple invisible positions; the regional memory bank is queried according to the invisible positions to obtain a first token feature; and at least one voxel feature is updated according to the first token feature, and multiple 3D scene categories are generated according to the updated voxel features.

### CROSS-REFERENCE TO RELATED APPLICATION

This application claims the priority benefit of U.S. provisional application Ser. No. 63/722,565, filed on Nov. 19, 2024 and Taiwan application serial no. 114136381, filed on Sep. 22, 2025. The entirety of each of the above-mentioned patent applications is hereby incorporated by reference herein and made a part of this specification.

### BACKGROUND

### Technical Field

The disclosure relates to a method and an electronic device for 3D semantic scene reconstruction, which use a memory bank to fill an invisible position.

### Related Art

With the rapid development of autonomous driving technology, the ability to correctly recognize object categories in a 3D scene has become one of the core technologies for autonomous driving systems to perform perception, planning, and decision-making. To achieve this goal, existing technologies mostly rely on deep learning models to analyze and classify visual data to recognize environmental elements such as vehicles, pedestrians, and traffic signs in the front visual field.

However, existing technologies generally have poor recognition effects. A main reason is that conventional models mostly process visible regions within a field of view (FOV), lacking effective processing mechanisms for an occluded region or an out-of-view region. Therefore, when there is a vehicle or a pedestrian occluded by other objects in the scene, or when an important object is located in a region about to enter the field of view, conventional technologies may not provide sufficient and complete perception information, leading to decreased reliability in autonomous driving decision-making.

### SUMMARY

The disclosure proposes a method for 3D semantic scene reconstruction, which is adapted to an electronic device. The method for 3D semantic scene reconstruction includes: a 2D image is obtained, and multiple token features and multiple voxel features are generated according to the 2D image; each of the token features is associated with a region; the token features are added to a regional memory bank; the regional memory bank includes multiple key-value pairs; a depth map is generated according to the 2D image, and a reconstruction mask is generated according to the depth map and the token features; the reconstruction mask includes multiple invisible positions; the regional memory bank is queried according to at least one of the invisible positions to obtain a first token feature; and at least one of the voxel features is updated according to the first token features, and multiple 3D scene categories are generated according to the updated voxel features.

In one embodiment of the disclosure, the method for 3D semantic scene reconstruction further includes: multiple similar token features among the token features are obtained for each of the token features to serve as a key, and the token feature is treated as a value, wherein the key and the value form a new key-value pair to be added to the key-value pairs.

In one embodiment of the disclosure, each of the token features has a position. The step of obtaining the similar token features among the token features to serve as the key includes: a difference between the positions corresponding to two of the token features is computed to obtain the similar token features.

In one embodiment of the disclosure, the method for 3D semantic scene reconstruction further includes: a diversity score and an age score for each of the key-value pairs are computed if a quantity of the key-value pairs is greater than a threshold value; and one of the key-value pairs is deleted according to the diversity score and the age score.

In one embodiment of the disclosure, the method for 3D semantic scene reconstruction further includes: a sum of cosine similarities between a value of the key-value pair and a value of the other key-value pair is computed to serve as the diversity score for each of the key-value pairs.

In one embodiment of the disclosure, the step of deleting one of the key-value pairs according to the diversity score and the age score includes: the age score is subtracted from the diversity score to obtain an overall score, and one of the key-value pairs having a minimum overall score is deleted.

In one embodiment of the disclosure, each of the token features has a position. The step of generating the reconstruction mask according to the depth map and the token features includes: multiple 3D coordinates are generated according to the depth map; the 3D coordinates is projected to a ground to obtain a visible mask; the visible mask is inverted to obtain an invisible mask; an expansion procedure is executed on the positions of the token features according to a core to obtain a regional mask; and a pixel-wise multiplication is executed on the regional mask and the invisible mask to obtain the reconstruction mask.

In one embodiment of the disclosure, the step of querying the regional memory bank according to at least one of the invisible positions to obtain the first token feature includes: multiple adjacent invisible positions among the invisible positions are taken to serve as a query; and the query and a key in the key-value pairs are compared to obtain a corresponding value to serve as the first token feature.

In one embodiment of the disclosure, the step of updating at least one of the voxel features according to the first token feature includes: at least one first voxel feature located at a bottom layer among the voxel features is obtained according to the adjacent invisible positions; and the at least one first voxel feature is replaced with the first token feature.

In one embodiment of the disclosure, generating the 3D scene categories according to the updated voxel features includes: the updated voxel features are input to a neural network to obtain a first output; the first output is added to the voxel features to obtain a second output; and the second output is input to a head to obtain the 3D scene categories.

From another perspective, embodiments of the disclosure provide an electronic device, which includes a memory and a processor. The processor is configured to execute commands in the memory to complete the foregoing method for 3D semantic scene reconstruction.

In the foregoing electronic device and method, the invisible positions may be found using the depth map, and then querying the regional memory bank may find features of the invisible positions, thereby allowing prediction of more accurate scene categories.

In order to make the features and advantages of the disclosure more comprehensible, the following examples are given and described in detail with the accompanying drawings as follows.

### BRIEF DESCRIPTION OF THE DRAWINGS

FIG. 1 is a block diagram of an electronic device according to one embodiment.

FIG. 2A and FIG. 2B are schematic diagrams of experimental results according to one embodiment.

FIG. 3 is a diagram of an architecture of a method for 3D semantic scene reconstruction according to one embodiment.

FIG. 4 is a flowchart of a method for 3D semantic scene reconstruction according to one embodiment.

### DESCRIPTION OF THE EMBODIMENTS

Some embodiments of the disclosure will be described in detail with reference to the accompanying drawings. The same reference numerals used in the following description and in different drawings will be regarded as referring to the same or similar elements. The embodiments are only part of the disclosure, and do not disclose all possible implementations of the disclosure. Rather, the embodiments are only examples of a system and a method within a scope of the patent application of the disclosure.

Terms such as “first” and “second” used herein do not represent order, and it should be understood that they are for differentiating devices or operations having the same technical terms.

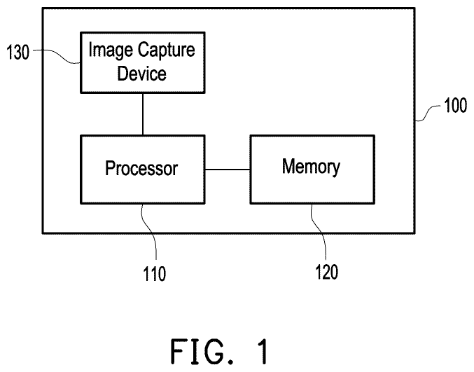

FIG. 1 is a block diagram of an electronic device according to one embodiment. Please refer to FIG. 1. An electronic device 100 may be a personal computer, a laptop computer, a server, a cloud server, an industrial computer, a surveillance system, a vehicle assistance system, an autonomous driving system, or various electronic devices with computing capabilities, etc. However, the disclosure is not limited thereto. The electronic device 100 includes a processor 110, a memory 120, and an image capture device 130. The processor 110 is electrically connected to the memory 120 and the image capture device 130. The processor 110 may include a central processing unit, a graphics processing unit (GPU), a deep-learning processing unit (DPU), a neural network processing unit (NPU), a tensor processing unit (TPU), an application specific integrated circuit (ASIC), or a programmable logic device (PLD). The memory 120 may be a random access memory, a read-only memory, a flash memory, a floppy disk, a hard disk, an optical disk, a USB drive, a magnetic tape, or a database accessible through the Internet. The image capture device 130 includes a charge-coupled device (CCD) sensor, a complementary metal-oxide semiconductor sensor, or other suitable photosensitive elements. Multiple commands are stored in the memory 120. The processor 110 executes the commands to complete a method for 3D semantic scene reconstruction.

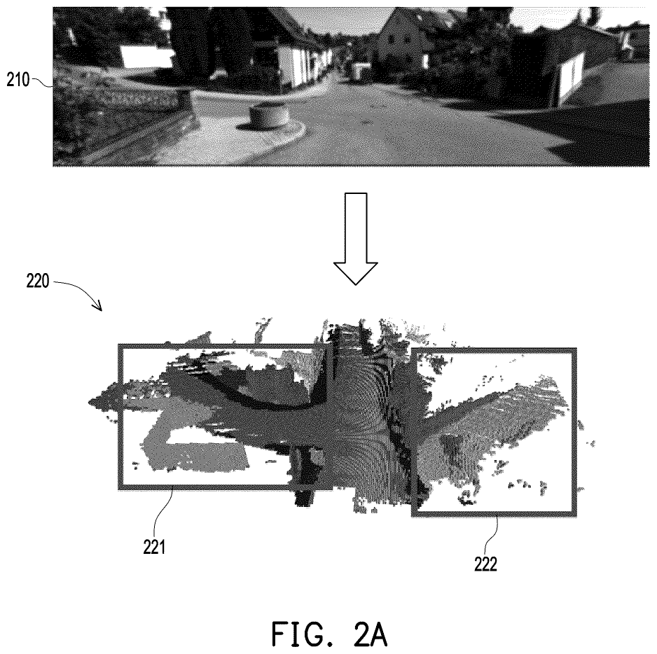

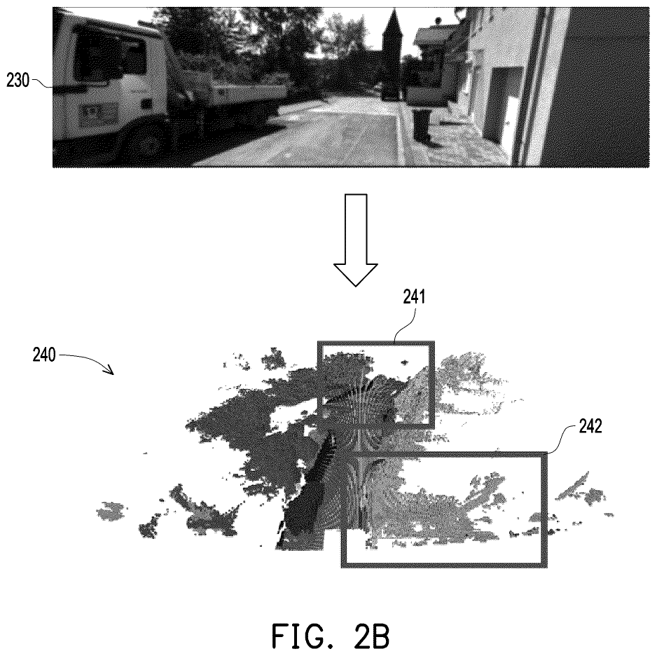

FIG. 2A and FIG. 2B are schematic diagrams of experimental results according to one embodiment. Please refer to FIG. 2A. In some embodiments, a method for 3D semantic scene reconstruction is configured for autonomous driving. A 2D image 210 is related to a road environment. After the method is executed, a prediction result 220 may be generated. The prediction result 220 includes multiple 3D scene categories. Different colors represent different categories. The categories may include a vehicle, a bicycle, a motorcycle, a truck, a pedestrian, a road, a parking space, a sidewalk, other ground, a building, a fence, a green area, a traffic sign, and other objects, etc. However, the disclosure is not limited thereto. Prior art has poor prediction accuracy for regions 221 and 222, because some objects therein are invisible. A reason for being invisible includes being occluded or being not within the scene. Please refer to FIG. 2B. A 2D image 230 is also related to a road environment. Through the foregoing method, a prediction result 240 may be generated. Prior art has poor prediction accuracy for regions 241 and 242. However, the method for 3D semantic scene reconstruction disclosed herein may compute the categories of the invisible regions.

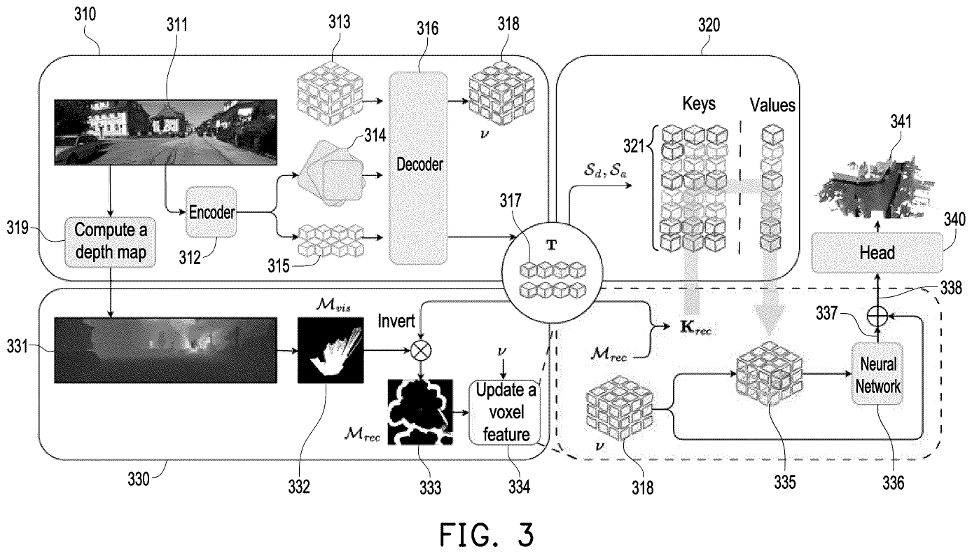

FIG. 3 is a diagram of an architecture of a method for 3D semantic scene reconstruction according to one embodiment. Please refer to FIG. 3. A method for 3D semantic scene reconstruction includes three main parts, which are respectively a semantic scene completion (SSC) stage 310, a regional memory bank 320, and a re-completion pipeline 330.

Please refer to FIG. 1 and FIG. 3. First, a 2D image 311 is captured by the image capture device 130. In the embodiment, the 2D image 311 is related to a road environment. However, in other embodiments, the 2D image 311 may also be related to a shopping mall, a factory, an airport, a school, or any location. However, the disclosure is not limited thereto. Next, according to the 2D image 311, multiple voxel features 318 and multiple token features 317 are generated. A length of a voxel feature may be the same as a length of a token feature. The voxel features 318 are arranged as a 3D matrix to be configured to include a feature at each position (that is, voxel) in a 3D space corresponding to the 2D image 311. The voxel features 318 may be configured to generate categories in a subsequent process. On the other hand, each of the token features 317 is related to a region in the 2D image 311. The regions may be a building, a road, grass, a vehicle, or a pedestrian, etc. A region is larger than a voxel but smaller than an entire scene, so the voxel features 318 are more detailed, while the semantics represented by the token features 317 are between the voxel features 318 and the entire scene.

Any prior art may be utilized here to generate the voxel features 318 and the token features 317. For example, the 2D image 311 may first be input to an encoder 312, which outputs 2D multi-scale features 314 and token features 315. On the other hand, voxel features 313 may be generated according to the 2D image 311 through other methods. Next, the voxel features 313, the 2D multi-scale features 314, and the token features 315 may be input to a decoder 316 to obtain the voxel features 318 and the token features 317. In the following mathematical representation, all of the token features 317 are represented as a set T, and the voxel features 318 are represented as V.

Next, the token features 317 are added to the regional memory bank 320. The regional memory bank 320 includes multiple key-value pairs 321. A key is composed of multiple token features. A value includes a token feature. The regional memory bank 320 is configured to retain previously appeared token features. These token features might have information of an invisible region in a current scene. Here, the memory bank is established at a regional level, which has the benefits of computational efficiency and easy management.

Specifically, for each tᵢϵT in the token features 317, multiple (such as three, but the disclosure is not limited thereto) similar token features may be searched to serve as a key. The three similar token features are represented as a set Kᵢ. A token feature tᵢ serves as a value. Therefore, a key-value pair {Kᵢ, tᵢ} may be formed. A similar token feature kₙϵKᵢ in the set Kᵢ is defined as the following mathematical formula 1.

$${k}_{n} = arg {min}_{{t}_{j}} [ d ( {t}_{i} , {t}_{j} ) ] ∀ i \neq j , 1 \leq j \leq \vert T \vert \qquad [ Mathematical Formula 1 ]$$

d( ) represents the distance between two token features. In other words, multiple similar token features tⱼ closest to the token feature tᵢ are found among token features T to establish the set Kᵢ. Each token feature has a position in a 3D space (that is, a position of a region). For example, the token feature tᵢ has a position pᵢ. The token feature tⱼ has a position pⱼ. In some embodiments, the function d( ) is defined as the following mathematical formula 2.

$$d ( {t}_{i} , {t}_{j} ) = {‖ {p}_{i} - {p}_{j} ‖}_{2} \qquad [ Mathematical Formula 2 ]$$

In other words, in the foregoing mathematical formulas 1 and 2, a difference between the positions corresponding to two of the token features is computed to obtain the similar token features. The difference is a Euclidean distance. However, in other embodiments, a Manhattan distance may also be utilized. However, the disclosure is not limited thereto.

After the new key-value pair {Kᵢ, tᵢ} is computed, the new key-value pair may be added to the existing key-value pairs 321 in the regional memory bank 320. In some embodiments, after the new key-value pair is added, if a quantity of all key-value pairs is greater than a threshold value (such as 1024), some key-value pairs may need to be deleted. Here, a diversity score and an age score of each of the key-value pairs may be computed. At least one of the key-value pairs is deleted according to the diversity score and the age score. Specifically, the diversity score is to retain the key-value pairs in the regional memory bank 320 to be diverse, so as to effectively capture regional information across the scene. In some embodiments, the computation of a diversity score S_{d} is as the following mathematical formula 3.

$${S}_{d} ( {t}_{i} ) = {\sum }_{i \neq j}^{\vert Ω \vert} \frac{{t}_{i} \cdot {t}_{j}}{‖ {t}_{i} ‖ \cdot \vert \vert {t}_{j} ‖} \qquad [ Mathematical Formula 3 ]$$

Ω represents a set. The set is a union between the existing token features in the regional memory bank 320 and the newly generated token features T. tᵢ and tⱼ are token features in the set Ω. From another perspective, after the new key-value pair is added to the existing key-value pairs, for a certain key-value pair, a sum of cosine similarities between the value tᵢ of the key-value pair and the value tⱼ of the other multiple key-value pairs is computed to serve as a diversity score S_{d}(tᵢ).

On the other hand, an age score is configured to filter out older information and retain new information. In some embodiments, an age score Sₐ is initialized as 0. A number (such as 1) is added every time one 2D image 311 is passed. For an i-th key-value pair, a corresponding age score is represented as Sₐ(tᵢ). Subtracting the age score Sₐ(tᵢ) from the diversity score S_{d}(tᵢ) may obtain an overall score S(tᵢ), as the following mathematical formula 4. Next, one or more of the key-value pairs having a minimum overall score may be deleted, so that a quantity of all key-value pairs is less than or equal to the threshold value. In other words, multiple key-value pairs having a highest overall score S(tᵢ) (such as a total of 1024) are retained here.

$$S ( {t}_{i} ) = {S}_{d} ( {t}_{i} ) - {S}_{a} ( {t}_{i} ) \qquad [ Mathematical Formula 4 ]$$

In addition, the re-completion pipeline 330 is to find an invisible position in the 2D image 311, and then query the regional memory bank 320 to update the voxel features 318. Specifically, first in step 319, a depth map 331 is computed according to the 2D image 311. A value of each pixel in the depth map 331 represents depth. Here, any prior art may be configured to compute the depth map 331. Next, a reconstruction mask 333 is generated according to the depth map 331 and the token features 317. The reconstruction mask 333 includes an invisible position.

Specifically, the depth map 331 may be projected to a 3D space to generate multiple 3D coordinates. The step may be completed according to the following mathematical formula 5.

$$x = \frac{( u - {ω}_{u} )}{{f}_{u}} z \qquad [ Mathematical Formula 5 ]$$

$$y = \frac{( v - {ω}_{v} )}{{f}_{v}} z$$

$$z = Z ( u , v )$$

ωᵤ and ωᵥ are respectively the horizontal coordinates and vertical coordinates of a camera center. fᵤ is the focal length in a horizontal direction. fᵥ is the focal length in a vertical direction. u is the horizontal coordinate of a pixel in the depth map 331. v is the vertical coordinate of a pixel in the depth map 331. z is the value Z(u, v) of a pixel located at a coordinate (u,v) in the depth map 331. This value represents depth. Accordingly, the coordinate (u,v) in the depth map may be converted to a 3D coordinate (x,y,z).

Next, the foregoing 3D coordinate (x,y,z) is projected to a ground to obtain a visible mask 332. For example, the Y coordinate representing height may be set as 0, that is, the 3D coordinate (x,y,z) may be reduced in dimension to become a 2D coordinate (x,z) on the visible mask. If there is a pixel projected from the depth map 331 to the 2D coordinate (x,z), a value of a corresponding pixel in the visible mask is “1”. Conversely, if there is no pixel projected from the depth map 331 to the 2D coordinate (x,z), a value of a corresponding pixel in the visible mask is “0”. The visible mask is represented as [symbol] below. If a value of a pixel in the visible mask [symbol] is 1, it indicates that a corresponding position has a visible object. If a value of a pixel is 0, it indicates that a corresponding position is invisible (might be occluded).

Next, the visible mask [symbol] is inverted to obtain an invisible mask, represented as [symbol] Specifically, the “inversion” here is to change the value “1” in the visible mask [symbol] to “0”, and change the value “0” to “1”. That is, a value “1” in the invisible mask [symbol] indicates that a position is invisible.

Next, according to a core, an expansion procedure is executed on a position of each of the token features 317 to obtain a regional mask. The core may be circular, square, or any shape. For example, the position of an i-th token feature 317 is pᵢ. With the position pᵢ as a center, values within a core range may all be set as 1. Therefore, the regional mask represents positions of all token features 317 (with slight expansion).

Next, pixel-wise multiplication is performed on the regional mask and the invisible mask [symbol] to obtain the reconstruction mask 333, represented as [symbol] Positions with a value “1” in the reconstruction mask 333 represent being invisible and having corresponding regional features 317. The positions with the value “1” are referred to as invisible positions.

Next, step 334 is executed, using the reconstruction mask 333 and the regional memory bank 320 to update the voxel features 318. Specifically, the regional memory bank 320 is queried according to at least one of the invisible positions to obtain a value in a certain key-value pair (also referred to as a first token feature). In the embodiment, three token features are combined to form one key, so three adjacent invisible positions (also referred to as adjacent invisible positions) may be taken to serve as a query, also represented as K_{rec} in FIG. 3. Then, the query K_{rec} is compared with a key in the key-value pairs 321 to find a most similar key and obtain a corresponding value to serve as the first token feature. In other words, the regional memory bank 320 may serve as a codebook configured to find a matching value. Every three adjacent invisible positions may form one query until all invisible positions are processed.

Next, at least one of the voxel features 318 is updated according to the matched first token feature. In the embodiment, since a value in the reconstruction mask 333 represents whether an object on the ground is visible, only a voxel feature corresponding to the ground may be updated. Specifically, at least one of the voxel features located at a bottom layer among the voxel features 318 (referred to as a first voxel feature) is obtained according to the foregoing adjacent invisible positions (that is, the positions included in the query K_{rec}). Then, the first voxel feature is replaced with the first token feature, thereby obtaining updated voxel features 335. In this way, the voxel features located at the invisible positions may be updated by information in the regional memory bank 320. The information may come from a previous scene.

Next, the multiple 3D scene categories are generated according to the updated voxel features 335. In the embodiment, since the voxel features are updated according to a value in the regional memory bank 320, there might be the problem of scale inconsistency. In some implementations, the updated voxel features 335 may first be input to a neural network 336 to obtain a first output 337. The neural network 336 is, for example, an atrous spatial pyramid pooling (ASPP) model. However, the disclosure is not limited thereto. Next, the first output 337 and the voxel features 318 are added to obtain a second output 338. Finally, the second output 338 is input to a head 340 to obtain a 3D scene category 341. The head 340 is a neural network, for example, including a convolutional layer or a fully connected layer.

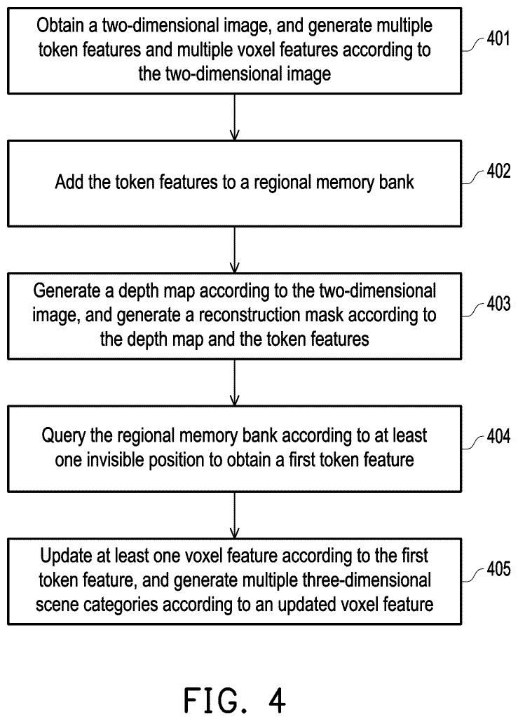

FIG. 4 is a flowchart of a method for 3D semantic scene reconstruction according to an embodiment. Please refer to FIG. 4. In step 401, a 2D image is obtained. Multiple token features and multiple voxel features are generated according to the 2D image. Each of the token features is associated with one region. In step 402, the token features are added to a regional memory bank, which includes multiple key-value pairs. In step 403, a depth map is generated according to the 2D image. A reconstruction mask is generated according to the depth map and the token features. The reconstruction mask includes multiple invisible positions. In step 404, the regional memory bank is queried according to at least one of the invisible positions to obtain a first token feature. In step 405, at least one of the voxel features is updated according to the first token feature, and multiple 3D scene categories are generated according to the updated voxel features. Each step in FIG. 4 has been described in detail above, and will not be elaborated here. It is worth noting that each step in FIG. 4 may be implemented as multiple codes or circuits. However, the disclosure is not limited thereto. In addition, the method of FIG. 4 may be used in conjunction with the foregoing embodiments or may be independently used. In other words, other steps may also be added between each step of FIG. 4.

From another perspective, the disclosure also proposes a computer program product. The product may be written by any programming language and/or platform. When the computer program product is loaded into a computer system and executed, the foregoing method may be executed.

Although the disclosure has been disclosed in the above embodiments, the embodiments are not intended to limit the disclosure. Persons skilled in the art may make some changes and modifications without departing from the spirit and scope of the disclosure. Therefore, the protection scope of the disclosure shall be defined by the appended claims.

What is claimed is:

1. A method for 3D semantic scene reconstruction, adapted to an electronic device, wherein the method for 3D semantic scene reconstruction comprises:
obtaining a 2D image, and generating a plurality of token features and a plurality of voxel features according to the 2D image, wherein each of the token features is associated with a region;
adding the token features to a regional memory bank, wherein the regional memory bank comprises a plurality of key-value pairs;
generating a depth map according to the 2D image, and generating a reconstruction mask according to the depth map and the token features, wherein the reconstruction mask comprises a plurality of invisible positions;
querying the regional memory bank according to at least one of the invisible positions to obtain a first token feature; and
updating at least one of the voxel features according to the first token feature, and generating a plurality of 3D scene categories according to the updated voxel features.

2. The method for 3D semantic scene reconstruction according to claim 1, further comprising:
obtaining a plurality of similar token features among the token features for each of the token features to serve as a key, and treating the token feature as a value, wherein the key and the value form a new key-value pair to be added to the key-value pairs.

3. The method for 3D semantic scene reconstruction according to claim 2, wherein each of the token features has a position, and the step of obtaining the similar token features among the token features to serve as the key comprises:
computing a difference between the positions corresponding to two of the token features to obtain the similar token features.

4. The method for 3D semantic scene reconstruction according to claim 3, further comprising:
computing a diversity score and an age score for each of the key-value pairs if a quantity of the key-value pairs is greater than a threshold value; and
deleting one of the key-value pairs according to the diversity score and the age score.

5. The method for 3D semantic scene reconstruction according to claim 4, further comprising:
computing a sum of cosine similarities between a value of the key-value pair and a value of the other key-value pair to serve as the diversity score for each of the key-value pairs.

6. The method for 3D semantic scene reconstruction according to claim 4, wherein the step of deleting one of the key-value pairs according to the diversity score and the age score comprises:
subtracting the age score from the diversity score to obtain an overall score, and deleting one of the key-value pairs having a minimum overall score.

7. The method for 3D semantic scene reconstruction according to claim 1, wherein each of the token features has a position, and the step of generating the reconstruction mask according to the depth map and the token features comprises:
generating a plurality of 3D coordinates according to the depth map;
projecting the 3D coordinates to a ground to obtain a visible mask;
inverting the visible mask to obtain an invisible mask;
executing an expansion procedure on the positions of the token features according to a core to obtain a regional mask; and
executing a pixel-wise multiplication on the regional mask and the invisible mask to obtain the reconstruction mask.

8. The method for 3D semantic scene reconstruction according to claim 7, wherein the step of querying the regional memory bank according to at least one of the invisible positions to obtain the first token feature comprises:
taking a plurality of adjacent invisible positions among the invisible positions to serve as a query; and
comparing the query and a key in the key-value pairs to obtain a corresponding value to serve as the first token feature.

9. The method for 3D semantic scene reconstruction according to claim 8, wherein the step of updating at least one of the voxel features according to the first token feature comprises:
obtaining at least one first voxel feature located at a bottom layer among the voxel features according to the adjacent invisible positions; and
replacing the at least one first voxel feature with the first token feature.

10. The method for 3D semantic scene reconstruction according to claim 9, wherein generating the 3D scene categories according to the updated voxel features comprises:
inputting the updated voxel features to a neural network to obtain a first output;
adding the first output to the voxel features to obtain a second output; and
inputting the second output to a head to obtain the 3D scene categories.

11. An electronic device, comprising:
a memory, storing a plurality of commands; and
a processor, electrically connected to the memory, and configured to execute the commands to complete a plurality of steps:
obtaining a 2D image, and generating a plurality of token features and a plurality of voxel features according to the 2D image, wherein each of the token features is associated with a region;
adding the token features to a regional memory bank, wherein the regional memory bank comprises a plurality of key-value pairs;
generating a depth map according to the 2D image, and generating a reconstruction mask according to the depth map and the token features, wherein the reconstruction mask comprises a plurality of invisible positions;
querying the regional memory bank according to at least one of the invisible positions to obtain a first token feature; and
updating at least one of the voxel features according to the first token feature, and generating a plurality of 3D scene categories according to the updated voxel features.

12. The electronic device according to claim 11, wherein the steps further comprise:
obtaining a plurality of similar token features among the token features for each of the token features to serve as a key, and treating the token feature as a value, wherein the key and the value form a new key-value pair to be added to the key-value pairs.

13. The electronic device according to claim 12, wherein each of the token features has a position, and the step of obtaining the similar token features among the token features to serve as the key comprises:
computing a difference between the positions corresponding to two of the token features to obtain the similar token features.

14. The electronic device according to claim 13, wherein the steps further comprise:
computing a diversity score and an age score for each of the key-value pairs if a quantity of the key-value pairs is greater than a threshold value; and
deleting one of the key-value pairs according to the diversity score and the age score.

15. The electronic device according to claim 14, wherein the steps further comprise:
computing a sum of cosine similarities between a value of the key-value pair and a value of the other key-value pair to serve as the diversity score for each of the key-value pairs.

16. The electronic device according to claim 14, wherein the step of deleting one of the key-value pairs according to the diversity score and the age score comprises:
subtracting the age score from the diversity score to obtain an overall score, and deleting one of the key-value pairs having a minimum overall score.

17. The electronic device according to claim 11, wherein each of the token features has a position, and the step of generating the reconstruction mask according to the depth map and the token features comprises:
generating a plurality of 3D coordinates according to the depth map;
projecting the 3D coordinates to a ground to obtain a visible mask;
inverting the visible mask to obtain an invisible mask;
executing an expansion procedure on the positions of the token features according to a core to obtain a regional mask; and
executing a pixel-wise multiplication on the regional mask and the invisible mask to obtain the reconstruction mask.

18. The electronic device according to claim 17, wherein the step of querying the regional memory bank according to at least one of the invisible positions to obtain the first token feature comprises:
taking a plurality of adjacent invisible positions among the invisible positions to serve as a query; and
comparing the query and a key in the key-value pairs to obtain a corresponding value to serve as the first token feature.

19. The electronic device according to claim 18, wherein the step of updating at least one of the voxel features according to the first token feature comprises:
obtaining at least one first voxel feature located at a bottom layer among the voxel features according to the adjacent invisible positions; and
replacing the at least one first voxel feature with the first token feature.

20. The electronic device according to claim 19, wherein generating the 3D scene categories according to the updated voxel features comprises:
inputting the updated voxel features to a neural network to obtain a first output;
adding the first output to the voxel features to obtain a second output; and
inputting the second output to a head to obtain the 3D scene categories.
